(19) United States
(12) Patent Application Publication
(10) Pub. No.: US 2026/0249705 A1
(43) Pub. Date: Aug. 27, 2026

(54) ADAPTIVE SEQUENCING STRATEGY FOR TORQUE BOOST FEATURE FOR ELECTRIFIED VEHICLES

(71) Applicant: FCA US LLC, Auburn Hills, MI (US)

(72) Inventors: Rakshith Kumar Janga, Auburn Hills, MI (US); Steven Hyde, Auburn Hills, MI (US)

(21) Appl. No.: 19/064,781

(22) Filed: Feb. 27, 2025

(51) Int. Cl. B60L 15/20

(52) U.S. Cl. CPC B60L 15/20; B60L 2240/12; B60L 2240/425; B60L 2250/26

(57) ABSTRACT

A torque control system and method for an electrified vehicle include a control system configured to receive a driver request for a torque boost feature of an electrified powertrain of the electrified vehicle, wherein the torque boost feature comprises operating the electrified powertrain to generate a maximum torque output that is greater than a normal torque output during operation outside of the torque boost feature and, when a set of enablement conditions for the torque boost feature are satisfied, temporarily enable the torque boost feature and operate the electrified powertrain at the maximum torque output for a finite period, determine a dynamic cool-off period for the electrified powertrain based on a difference between actual temperatures of the set of components and critical threshold temperatures of the set of components, and selectively disable or prevent further enablement of the torque boost feature for the dynamic cool-off period.

### FIELD

The present application generally relates to electrified vehicles and, more particularly, to an adaptive sequencing strategy for a torque boost feature for electrified vehicles.

### BACKGROUND

Electrified vehicles (e.g., battery electric vehicles, or BEVs) have electrified powertrains including one or more electric motors configured to provide propulsive torque. This typically involves an inverter that converts direct current DC) energy to alternating current (AC) energy to power windings of a respective electric motor, which in turn generate propulsive drive torque. In contrast to high-performance internal combustion engine powered vehicles, which can have a larger degree of capability in their output torque, electrified vehicles are often limited to a certain maximum torque output. This is one perceived disadvantage and barrier-to-entry for electrified vehicles compared to conventional engine-only vehicles. For example, a driver of an electrified vehicle may perceive difficulty in passing another vehicle on a highway, which could result in driver dissatisfaction. Accordingly, while these electrified powertrains and do work well for their intended purpose, there exists an opportunity for improvement in the relevant art.

### SUMMARY

According to one example aspect of the invention, a torque control system for an electrified vehicle is presented. In one exemplary implementation, the torque control system comprises a set of sensors configured to measure a set of operating parameters of an electrified powertrain of the electrified vehicle, the set of operating parameters including at least a set of temperatures of a set of components of the electrified powertrain, respectively and a control system configured to receive a driver request for a torque boost feature of the electrified powertrain, wherein the torque boost feature comprises operating the electrified powertrain to generate a maximum torque output that is greater than a normal torque output during operation outside of the torque boost feature and, when a set of enablement conditions for the torque boost feature are satisfied, temporarily enable the torque boost feature and operate the electrified powertrain at the maximum torque output for a finite period, determine a dynamic cool-off period for the electrified powertrain based on a difference between actual temperatures of the set of components and critical threshold temperatures of the set of components, and selectively disable or prevent further enablement of the torque boost feature for the dynamic cool-off period.

In some implementations, the control system is further configured to complete the torque boost feature after the finite period, determine whether at least one actual temperature of the set of components exceed its respective critical threshold temperature, and when the at least one actual temperature of the set of components exceeds its respective critical threshold temperature, wait for the dynamic cool-off period before a subsequent reengagement of the torque boost feature. In some implementations, the control system is further configured to when no actual temperatures of the set of components exceed their respective critical threshold temperatures, set the dynamic cool-off period to zero and redetermine whether the set of enablement conditions for the torque boost feature are satisfied for a subsequent driver request for the torque boost feature.

In some implementations, the control system is configured to determine the dynamic cool-off period by determining a temperature delta for each component of the set of component based on that component's actual and critical threshold temperatures, determining a cool-off period for each component of the set of components based on its temperature delta, and determining a maximum of the cool-off periods for each component of the set of components to determine the dynamic cool-off period. In some implementations, the control system is configured to determine the cool-off periods for each component of the set of components using a predetermined calibratable look-up table.

In some implementations, the finite period is a predetermined calibratable period defining a duration that is not likely to cause any temperatures of the set of components to exceed or substantially exceed their respective critical threshold temperatures. In some implementations, the finite period is within a range of 15 to 40 seconds. In some implementations, the set of enablement conditions for the torque boost feature includes a speed of the electrified vehicle being greater than a speed threshold. In some implementations, the speed threshold is greater than zero. In some implementations, the electrified vehicle is a battery electric vehicle (BEV) and the set of components includes at least one inverter and at least one electric motor.

According to another example aspect of the invention, a torque control method for an electrified vehicle is presented. In one exemplary implementation, the torque control method comprises monitoring, by a set of sensors of the electrified vehicle, a set of operating parameters of an electrified powertrain of the electrified vehicle, the set of operating parameters including at least a set of temperatures of a set of components of the electrified powertrain, respectively, receiving, by a control system of the electrified vehicle, a driver request for a torque boost feature of the electrified powertrain, wherein the torque boost feature comprises operating the electrified powertrain to generate a maximum torque output that is greater than a normal torque output during operation outside of the torque boost feature, and when a set of enablement conditions for the torque boost feature are satisfied, temporarily enabling, by the control system, the torque boost feature and operate the electrified powertrain at the maximum torque output for a finite period, determining, by the control system, a dynamic cool-off period for the electrified powertrain based on a difference between actual temperatures of the set of components and critical threshold temperatures of the set of components, and selectively disabling or preventing further enablement, by the control system, of the torque boost feature for the dynamic cool-off period.

In some implementations, the torque control method further comprises completing, by the control system, the torque boost feature after the finite period, determining, by the control system, whether at least one actual temperature of the set of components exceed its respective critical threshold temperature, and when the at least one actual temperature of the set of components exceeds its respective critical threshold temperature, waiting, by the control system, for the dynamic cool-off period before a subsequent reengagement of the torque boost feature. In some implementations, the torque control method further comprises when no actual temperatures of the set of components exceed their respective critical threshold temperatures, setting, by the control system, the dynamic cool-off period to zero and redetermining, by the control system, whether the set of enablement conditions for the torque boost feature are satisfied for a subsequent driver request for the torque boost feature.

In some implementations, the determining of the dynamic cool-off period includes determining, by the control system, a temperature delta for each component of the set of component based on that component's actual and critical threshold temperatures, determining, by the control system, a cool-off period for each component of the set of components based on its temperature delta, and determining, by the control system, a maximum of the cool-off periods for each component of the set of components to determine the dynamic cool-off period. In some implementations, the determining of the cool-off periods for each component of the set of components is performed by the control system using a predetermined calibratable look-up table.

In some implementations, the finite period is a predetermined calibratable period defining a duration that is not likely to cause any temperatures of the set of components to exceed or substantially exceed their respective critical threshold temperatures. In some implementations, the finite period is within a range of 15 to 40 seconds. In some implementations, the set of enablement conditions for the torque boost feature includes a speed of the electrified vehicle being greater than a speed threshold. In some implementations, the speed threshold is greater than zero. In some implementations, the electrified vehicle is a BEV and the set of components includes at least one inverter and at least one electric motor.

Further areas of applicability of the teachings of the present application will become apparent from the detailed description, claims and the drawings provided hereinafter, wherein like reference numerals refer to like features throughout the several views of the drawings. It should be understood that the detailed description, including disclosed embodiments and drawings referenced therein, are merely exemplary in nature intended for purposes of illustration only and are not intended to limit the scope of the present disclosure, its application or uses. Thus, variations that do not depart from the gist of the present application are intended to be within the scope of the present application.

### BRIEF DESCRIPTION OF THE DRAWINGS

FIG. 1 is a functional block diagram of an electrified vehicle having an example torque control system according to the principles of the present application;

FIG. 2 is a flow diagram of an adaptive sequencing strategy for a torque boost feature of an electrified vehicle according to the principles of the present application; and

FIG. 3 is an adaptive sequence state diagram for a torque boost feature of an electrified vehicle according to the principles of the present disclosure.

### DESCRIPTION

As previously discussed, in contrast to high-performance internal combustion engine powered vehicles, which can have a larger degree of capability in their output torque, electrified vehicles are often limited to a certain maximum torque output. This is one perceived disadvantage and barrier-to-entry for electrified vehicles compared to conventional engine-only vehicles. One potential solution to this problem could be to normally operate the electrified powertrain at less than its maximum torque output, thereby creating a torque reserve. Then, in response to a driver request for a temporary torque boost, this torque reserve could be depleted by temporarily increasing the electrified powertrain's torque output to its maximum level. This operation of the electrified powertrain at its maximum torque output could potentially cause temperatures of critical components (inverter(s), electric motor(s), etc.) to increase beyond critical threshold temperatures. Thus, a cool-off period could be initiated after the temporary torque boost where the electrified powertrain returns to its normal (less than maximum) torque output levels to allow the temperatures of these critical components to decrease.

In one approach, this cool-off period could be a predetermined duration and could always be commanded after every initiation of the torque boost. However, there could be scenarios where the torque boost has a short duration (via the driver's acceleration) or otherwise does not cause the temperatures of the critical components to exceeds their critical threshold temperatures. Thus, the torque boost could be unavailable until after the mandatory cool-off period, even though another instance of the torque boost could be available (i.e., based on the temperatures of the critical components). Accordingly, a new and improved adaptive sequencing strategy for controlling this torque boost (hereinafter, “torque boost feature”) is presented herein. This strategy gives the driver the ability to engage in multiple continuous bursts of the torque boost feature until temperature-based protection is needed. Potential benefits include an improved driver perception/experience in using the torque boost feature.

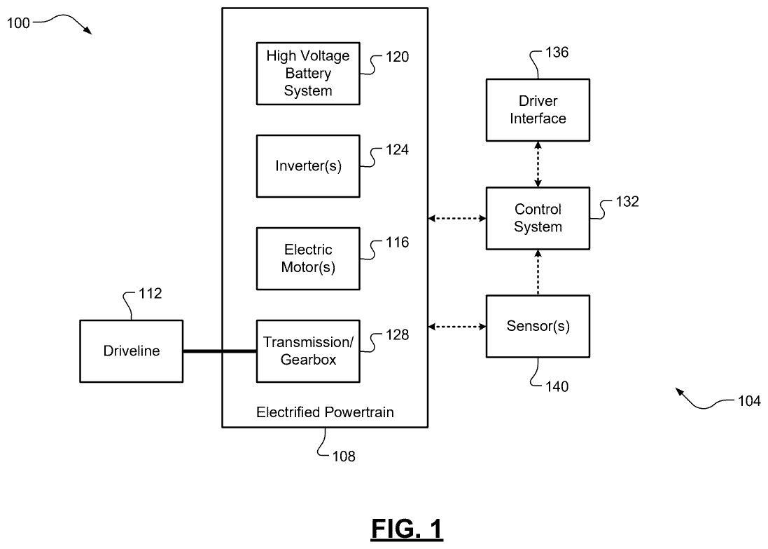

Referring now to FIG. 1, a functional block diagram of an electrified vehicle 100 having an example torque control system 104 according to the principles of the present application is illustrated. While the electrified vehicle 100 is shown to have a battery electric vehicle (BEV) configuration, it will be appreciated that the techniques of the present application could also be applicable to hybrid electric vehicles (HEV) that also include an internal combustion engine, such as for battery system recharging or propulsive torque support. The electrified vehicle 100 comprises an electrified powertrain 108 that is configured to generate and transfer drive torque to a driveline 112 for vehicle propulsion. The electrified powertrain 108 includes one or more electric motors 116 that powered by a high voltage battery pack or system 120 and respective inverters 124. For example, each inverter 124 could convert direct current (DC) electrical energy from the high voltage battery system 120 to alternating current (AC) electrical energy for powering windings (not shown) of the respective electric motor 116. The torque generated by the electric motor(s) 116 is transferred to the driveline 112 via one or more transmissions or gearboxes 128.

A controller or control system 132 controls operation of the electrified vehicle 100, which primarily includes controlling the electrified powertrain 108 to generate an amount of drive torque to satisfy a driver torque request. The driver torque request could be provided by a driver of the electrified vehicle 100 via a driver interface 136 (e.g., via an accelerator pedal). The driver interface 136 could also be configured to receive a driver request for enablement/engagement of the torque boost feature (e.g., via a steering wheel button or paddle shifter). The control system 132 is also configured to control the engagement/disengagement of the torque boost feature, which includes determining whether enablement condition(s) are satisfied and also determining whether any temperatures of the critical components of the electrified powertrain 108 (the inverter(s) 124, the electric motor(s) 116, etc.) have exceeded respective critical threshold temperatures where a cool-off period should be initiated. While the inverter(s) 124 and the electric motor(s) 116 are specifically referenced as examples of the critical components for the torque boost feature, it will be appreciated that there could be other critical components/temperatures (e.g., the high voltage battery system 120). The control system 132 receives a set of measured operating parameters of the electrified vehicle 100 from a set of sensors 140, which are configured to measure speeds (e.g., vehicle speed), component temperatures, and the like.

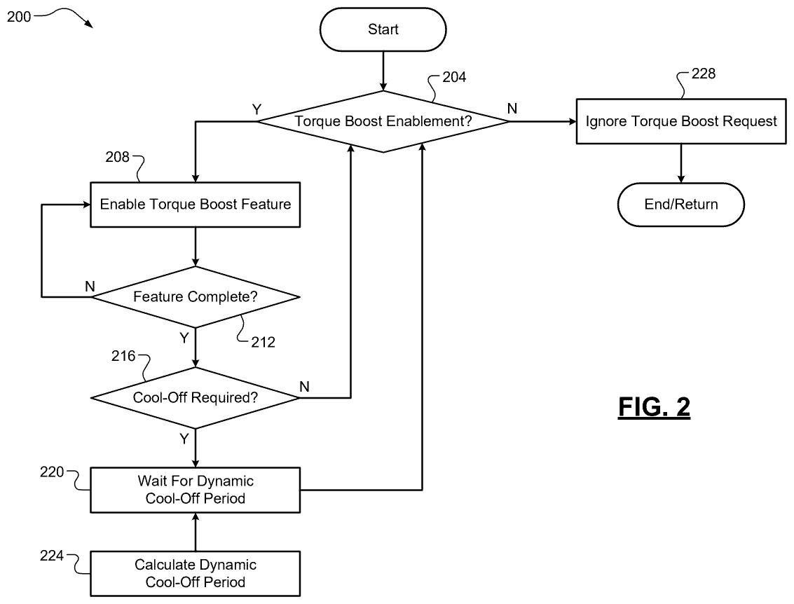

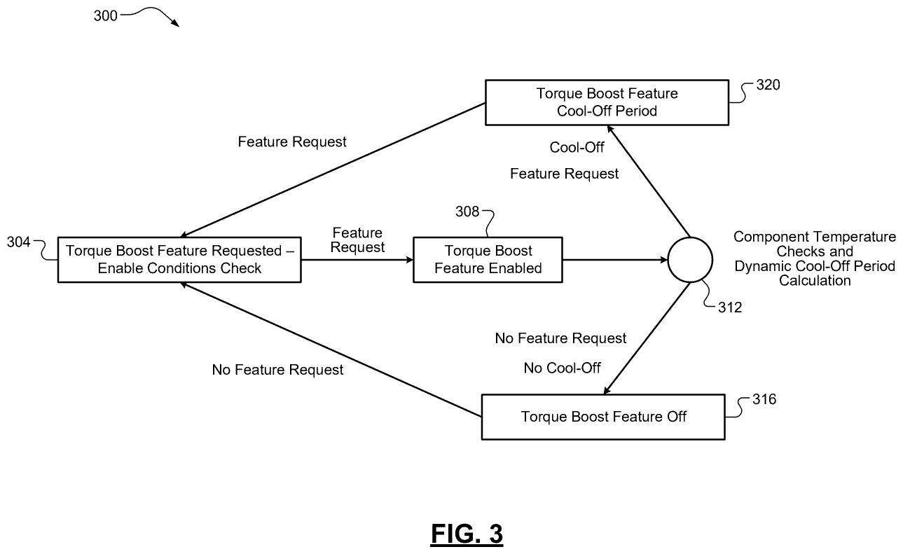

Referring now to FIGS. 2-3 and with continued reference to FIG. 1, a flow diagram 200 and an adaptive sequence state diagram 300 of a torque control method for a torque boost feature of an electrified vehicle according to the principles of the present application are illustrated. While the description of these diagrams 200, 300 specifically references the electrified vehicle 100 and its components, it will be appreciated that these diagrams 200, 300 could be applicable to other suitably configured electrified vehicles (BEVs, HEVs, etc.). In FIG. 2, the flow diagram 200 (hereinafter, “method 200”) begins at 204. At 204, the control system 132 determines whether a set of enablement conditions for the torque boost feature are satisfied. This is also shown as state 304 of state diagram 300. These could include, for example, the driver request for the torque boost feature being received and the temperatures of the critical components being less than their respective critical threshold temperatures. In some embodiments, the set of enablement conditions could also include the vehicle speed being greater than zero, such as at 30 or more miles per hour. In other words, the torque boost feature could be limited to driving scenarios and not for vehicle launch control from a standstill.

When the set of enablement conditions are satisfied, the method 200 proceeds to 208. Otherwise, the method 200 proceeds to 228 where the control system 132 cancels or ignores the driver request for the torque boost feature (i.e., the torque boost feature is not enabled) and the method 200 ends or returns to 204. At 208, the control system 132 enables the torque boost feature. This also corresponds to state 308 of state diagram 300. The torque boost feature depletes the previously-described torque reserve and provides increased torque output of the electrified powertrain 108. The torque boost feature, however, only operates for a finite period, which could be a predetermined calibratable period of, for example only, 15-40 seconds. The duration of this finite period is calibrated and set such that it is not likely to cause any temperatures of the critical components to exceed or substantially exceed their respective critical threshold temperatures. For example only, the duration of the finite period could be determined to have a degree of probability (e.g., a probability score) that operation of the electrified powertrain 108 for the finite period will not cause any of the critical component temperatures to exceed their respective critical threshold temperatures. After the finite period expires at 212, the control system 132 determines whether a cool-off period is required at 216. This includes determining whether any of the critical component temperatures exceed their respective critical threshold temperatures. This also corresponds to state 312 of state diagram 300.

When the cool-off period is not required, the method 200 returns to 204. This also corresponds to state 316 (and then state 304) of state diagram 300. At 216, when the control system 132 determines that the cool-off period for the torque boost feature is required, the method 200 proceeds to 220. In a separate or parallel branch of the method 200, the control system 132 determines a dynamic cool-off period for the torque boost feature based on the temperatures of the critical components and their respective critical threshold temperatures at 224. This also corresponds to state 312 of state diagram 300. In one embodiment, this further involves (i) determining a temperature delta for each critical component (i.e., a difference between it's actual/measured and critical threshold temperature, or vice-versa), (ii) determining a cool-off period for each critical component based on its temperature delta (e.g., using a predetermined calibratable look-up table), and (iii) determining the dynamic cool-off period for the entire system based on the cool-off periods for the critical components (e.g., a maximum of the cool-off periods). After determining this dynamic cool-off period at 224, the control system 132 can then wait for the dynamic cool-off period at 220 (e.g., wait for a timer to expire). After the dynamic cool-off period, the method 200 can then return to 204. This is also shown as state 320 (and then state 304) in the state diagram 300.

It will be appreciated that the terms “controller” and “control system” as used herein refer to any suitable control device or set of multiple control devices that is/are configured to perform at least a portion of the techniques of the present application. Non-limiting examples include an application-specific integrated circuit (ASIC), one or more processors and a non-transitory memory having instructions stored thereon that, when executed by the one or more processors, cause the controller to perform a set of operations corresponding to at least a portion of the techniques of the present application. The one or more processors could be either a single processor or two or more processors operating in a parallel or distributed architecture.

It should also be understood that the mixing and matching of features, elements, methodologies and/or functions between various examples may be expressly contemplated herein so that one skilled in the art would appreciate from the present teachings that features, elements and/or functions of one example may be incorporated into another example as appropriate, unless described otherwise above.

What is claimed is:

1. A torque control system for an electrified vehicle, the torque control system comprising:
a set of sensors configured to measure a set of operating parameters of an electrified powertrain of the electrified vehicle, the set of operating parameters including at least a set of temperatures of a set of components of the electrified powertrain, respectively; and
a control system configured to:
receive a driver request for a torque boost feature of the electrified powertrain, wherein the torque boost feature comprises operating the electrified powertrain to generate a maximum torque output that is greater than a normal torque output during operation outside of the torque boost feature; and
when a set of enablement conditions for the torque boost feature are satisfied:
temporarily enable the torque boost feature and operate the electrified powertrain at the maximum torque output for a finite period;
determine a dynamic cool-off period for the electrified powertrain based on a difference between actual temperatures of the set of components and critical threshold temperatures of the set of components; and
selectively disable or prevent further enablement of the torque boost feature for the dynamic cool-off period.

2. The torque control system of claim 1, wherein the control system is further configured to:
complete the torque boost feature after the finite period;
determine whether at least one actual temperature of the set of components exceed its respective critical threshold temperature; and
when the at least one actual temperature of the set of components exceeds its respective critical threshold temperature, wait for the dynamic cool-off period before a subsequent reengagement of the torque boost feature.

3. The torque control system of claim 2, wherein the control system is further configured to when no actual temperatures of the set of components exceed their respective critical threshold temperatures:
set the dynamic cool-off period to zero; and
redetermine whether the set of enablement conditions for the torque boost feature are satisfied for a subsequent driver request for the torque boost feature.

4. The torque control system of claim 1, wherein the control system is configured to determine the dynamic cool-off period by:
determining a temperature delta for each component of the set of component based on that component's actual and critical threshold temperatures;
determining a cool-off period for each component of the set of components based on its temperature delta; and
determining a maximum of the cool-off periods for each component of the set of components to determine the dynamic cool-off period.

5. The torque control system of claim 4, wherein the control system is configured to determine the cool-off periods for each component of the set of components using a predetermined calibratable look-up table.

6. The torque control system of claim 1, wherein the finite period is a predetermined calibratable period defining a duration that is not likely to cause any temperatures of the set of components to exceed or substantially exceed their respective critical threshold temperatures.

7. The torque control system of claim 6, wherein the finite period is within a range of 15 to 40 seconds.

8. The torque control system of claim 1, wherein the set of enablement conditions for the torque boost feature includes a speed of the electrified vehicle being greater than a speed threshold.

9. The torque control system of claim 8, wherein the speed threshold is greater than zero.

10. The torque control system of claim 1, wherein the electrified vehicle is a battery electric vehicle (BEV) and the set of components includes at least one inverter and at least one electric motor.

11. A torque control method for an electrified vehicle, the torque control method comprising:
monitoring, by a set of sensors of the electrified vehicle, a set of operating parameters of an electrified powertrain of the electrified vehicle, the set of operating parameters including at least a set of temperatures of a set of components of the electrified powertrain, respectively;
receiving, by a control system of the electrified vehicle, a driver request for a torque boost feature of the electrified powertrain, wherein the torque boost feature comprises operating the electrified powertrain to generate a maximum torque output that is greater than a normal torque output during operation outside of the torque boost feature; and
when a set of enablement conditions for the torque boost feature are satisfied:
temporarily enabling, by the control system, the torque boost feature and operate the electrified powertrain at the maximum torque output for a finite period;
determining, by the control system, a dynamic cool-off period for the electrified powertrain based on a difference between actual temperatures of the set of components and critical threshold temperatures of the set of components; and
selectively disabling or preventing further enablement, by the control system, of the torque boost feature for the dynamic cool-off period.

12. The torque control method of claim 11, further comprising:
completing, by the control system, the torque boost feature after the finite period;
determining, by the control system, whether at least one actual temperature of the set of components exceed its respective critical threshold temperature; and
when the at least one actual temperature of the set of components exceeds its respective critical threshold temperature, waiting, by the control system, for the dynamic cool-off period before a subsequent reengagement of the torque boost feature.

13. The torque control method of claim 12, further comprising when no actual temperatures of the set of components exceed their respective critical threshold temperatures:
setting, by the control system, the dynamic cool-off period to zero; and
redetermining, by the control system, whether the set of enablement conditions for the torque boost feature are satisfied for a subsequent driver request for the torque boost feature.

14. The torque control method of claim 11, wherein the determining of the dynamic cool-off period includes:
determining, by the control system, a temperature delta for each component of the set of component based on that component's actual and critical threshold temperatures;
determining, by the control system, a cool-off period for each component of the set of components based on its temperature delta; and
determining, by the control system, a maximum of the cool-off periods for each component of the set of components to determine the dynamic cool-off period.

15. The torque control method of claim 14, wherein the determining of the cool-off periods for each component of the set of components is performed by the control system using a predetermined calibratable look-up table.

16. The torque control method of claim 11, wherein the finite period is a predetermined calibratable period defining a duration that is not likely to cause any temperatures of the set of components to exceed or substantially exceed their respective critical threshold temperatures.

17. The torque control method of claim 16, wherein the finite period is within a range of 15 to 40 seconds.

18. The torque control method of claim 11, wherein the set of enablement conditions for the torque boost feature includes a speed of the electrified vehicle being greater than a speed threshold.

19. The torque control method of claim 18, wherein the speed threshold is greater than zero.

20. The torque control method of claim 11, wherein the electrified vehicle is a battery electric vehicle (BEV) and the set of components includes at least one inverter and at least one electric motor.
